(19) United States
(12) Patent Application Publication
(10) Pub. No.: US 2015/0356535 A1
(43) Pub. Date: Dec. 10, 2015

(54) MODULAR MULTI-COMPONENT CHECKOUT STAND

(71) Applicants: Jeffrey T. HASSMAN, (US); Ben CREDLE, (US); Shane GUINED, (US); ROYSTON LLC, Jasper, GA (US)

(72) Inventors: Jeffrey T Hassman, Canton, GA (US); Ben Credle, Athens, GA (US); Shane Guined, Cumming, GA (US)

(73) Assignee: ROYSTON LLC, Jasper, GA (US)

(21) Appl. No.: 14/760,104

(22) PCT Filed: Jan. 10, 2014
(86) PCT No.: PCT/US14/11154

§ 371 Date: Jul. 9, 2015

Related U.S. Application Data
(60) Provisional application No. 61/751,864, filed on Jan. 12, 2013.

(51) Int. Cl. G06Q 20/18; G06Q 20/20

(52) U.S. Cl. CPC G06Q 20/18; G06Q 20/208

(57) ABSTRACT

A modular checkout stand system including a number of modules that function independently of each other. The various modules may include intake transport sections, scanning sections, outtake transport sections, bagging sections, and other sections. These sections can be operatively coupled together in numerous different orientations and with varying numbers of each of the different sections to create customized checkout stands to meet the particular needs and applications of a merchant.

### CROSS REFERENCES TO RELATED APPLICATIONS

This application claims priority to U.S. Provisional Patent Application Ser. No. 61/751,864, filed Jan. 12, 2013, which is incorporated herein by reference in its entirety.

### BACKGROUND

The disclosure relates to checkout systems in retail establishments and methods for using such checkout systems.

### SUMMARY

Specific embodiments include a checkout stand comprising a scanner; a conveyor coupled to the scanner; an outtake section downstream of the scanner; a bagging station downstream of the outtake section; and a point of sale terminal. The various sections, for example, the outtake section and the bagging station, can be modular units.

### BRIEF DESCRIPTION OF THE DRAWINGS

The detailed description refers to the accompanying figures which are meant to be exemplary and not limiting, and in which:

FIG. 1 is perspective view of an embodiment of a checkout system;

FIG. 2A illustrates an embodiment of a modular checkout stand system;

FIG. 2B illustrates an embodiment of the modular checkout stand system;

FIG. 2C illustrates an embodiment of a modular checkout stand system;

FIG. 2D illustrates an embodiment of the modular checkout stand system;

FIG. 3 illustrates an embodiment in which a payment station is integrated into a main body of the modular checkout stand system;

FIG. 4 illustrates an embodiment in which the payment station is remote from the main body of the modular checkout stand system;

FIG. 5 illustrates sections of the modular checkout stand system;

FIG. 6 illustrates another embodiment of the modular checkout stand with a carousel bagging section; and

FIG. 7 illustrates the modular units of one specific embodiment.

FIG. 8A shows an exemplary modular checkout stand having two outtake transport sections.

FIG. 8B shows an exemplary modular checkout stand having six outtake transport sections.

### DETAILED DESCRIPTION

The following discussion of embodiments of the present disclosure illustrates many of the attendant advantages of the embodiments, and demonstrates that various changes may be made in the form, construction and arrangement of the parts without departing from the sprit or scope of the disclosure, the forms described herein being merely exemplary embodiments thereof. Therefore, certain functional details disclosed herein are not to be interpreted as limiting, but merely as a basis for the claims and as a representative basis for teaching one skilled in the art to variously employ the present disclosure.

Embodiments are described herein that provide checkout terminals and counters with enhanced convenience and flexibility, as well as methods for using such terminals and counters in retail establishments. Many stores have checkout stands to handle the payment and bagging of merchandise purchased by customers. These checkout stands are used by stores that sell several items to an individual customer. For example, they are commonly used in grocery stores of any size for handling the purchase and payment of groceries. For example, items of merchandise are scanned by a barcode reader, and other scanners which may use laser, imaging or radio-frequency identification (RFID) technology. The items are transported via a moving transport path to a bagging area. Some checkout stands may include a scale for weighing items such as produce. Customers pay for the merchandise at a tender or payment section of the checkout stand.

Embodiments of a checkout stand system 100 (as illustrated in the FIGS.) can be modular in nature, with one or more portions functioning independently of the other. The modular checkout stand system 100 can allow a checkout stand to be assembled with different numbers of sections of the same type. For example, one modular checkout stand might be configured with two outtake transport sections while another is configured with six outtake transport sections 160. Yet another is configured with more than six outtake transport sections. The limitation on the number of outtake transport sections or other units is space and checkout optimization. The modular checkout stand system 100 allows a checkout stand to be assembled with different locations for particular sections. For example, one checkout stand might be configured with a tender section in a location between the intake transport section and one of the outtake transport sections, while another checkout stand might be configured with a tender section in a remote location.

The components of the checkout stand system 100 are operatively connected, that is connected to allow the checkout stand to function accordingly. For example, the components may be connected to one another using fasteners, such as bolts or screws; adhesives; tongue and groove connections, and other connections. The components may also include electrical connections that can be connected to one another, such as male and female plugs.

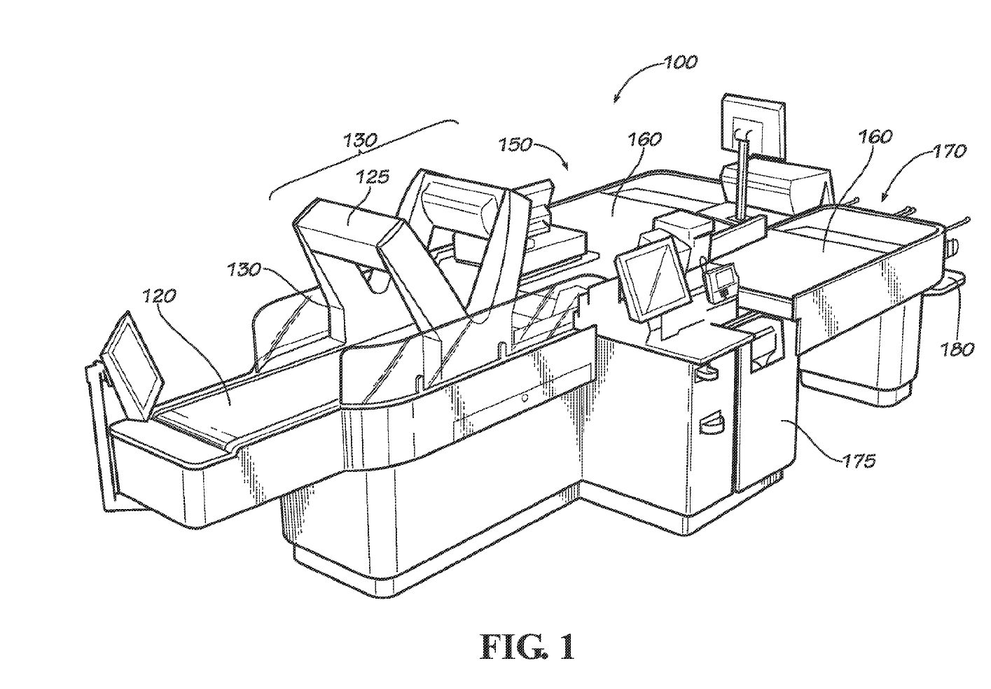

The sections of the modular checkout stand system 100 are described in connection with FIG. 1. An intake transport section 110 resides in a front portion of the modular checkout stand system 100. The intake transport section 110 includes an intake transport path 120, which may be implemented, for example, by a conveyor belt or set of rollers. Items are moved by the intake transport path 120 from an entry end of the checkout stand system to a scanning section 130 of the modular checkout stand system 100. In one example embodiment, the transport path 120 includes a belt and one or more motors for moving the belt. In another example embodiment, the transport path 120 includes rollers, each one mounted slightly lower than the preceding one, so as to form a downwardly sloped conveying surface from a first end of the transport path 120 to a second end. A payment machine can sit downstream of the transport path 120.

A barcode reader 125 (an exemplary scanner) in the scanning section 130 identifies the item by reading a barcode. The barcode reader 125 may be a portal or a 360 degree scanner, such as, a generally O-shaped or square-shaped barcode reader, so that items can be scanned without regard to the particular orientation of the barcode relative to the scanner. In an example embodiment, the barcode reader 125 is located at a second end of checkout stand housing. The barcode reader 125 may include any type of barcode reader. For example, barcode reader 125 may include an optical barcode reader which includes one or more lasers, mirrored spinners, collectors, detectors, or a plurality of pattern mirrors for directing laser light to create a scan pattern of laser beams for illuminating a barcode. As another example, the barcode reader 125 may include an imaging device, such as a camera, for capturing an image including a barcode. In another example, the barcode reader 125 may include a combination of an optical barcode reader and an imaging device. The barcode reader 125 may read a barcode from one or more directions. For example, the barcode reader 125 may include a substantially horizontal aperture that may also be substantially flush with a section of the conveyor 122 or intake transport section 110. From this aperture, the barcode reader 125 may read a barcode on a bottom surface of an item, and possibly other sides of the item, or even a top side. As another example, the barcode reader 125 may include a substantially vertical aperture. From this aperture, the barcode reader 125 may read a barcode on a side of an item facing this surface, and possibly other sides of the item.

From the scanning section 130 (the general position of the barcode reader 125), items proceed along the intake transport path 120 to a diverter 140, which directs each item to one of a plurality of outtake transport sections 150. In one example, after scanning an item, the customer places the item on the first flat take-away belt which moves the item to the second flat take-away belt which moves the item towards a bagging station. The take-away belts could be constructed as a single belt or as multiple belts. Each outtake transport section 150 has an outtake transport path 160 leading to a different collection or bagging section 170. Two outtake transport sections 150 are shown in the embodiment of FIG. 1, but other numbers are contemplated. The customer pays for the items at a tender or payment station 175. The configuration of the checkout stand system 100 can facilitate ergonomic flow.

The various sections, for example, the intake transport section(s) 110, scanning section(s) 130, outtake transport section(s) 150, bagging section(s) 170, etc. are modular. This allows the sections to be assembled in numerous different orientations and with varying numbers of each of the different sections to create customized checkout stands to meet the particular needs and applications of the merchant. In one embodiment, each section or unit has an independent frame and can stand on its own.

The bagging section 170 of the modular checkout stand system 100 can be configured with different bagging platform assemblies 180. For example, the bagging platform assemblies 180 may differ in their orientation or in the type of support. The outtake transport section 150 is adapted to fit with each of these bagging platform assemblies 180. That is, the assemblies 180 are interchangeable.

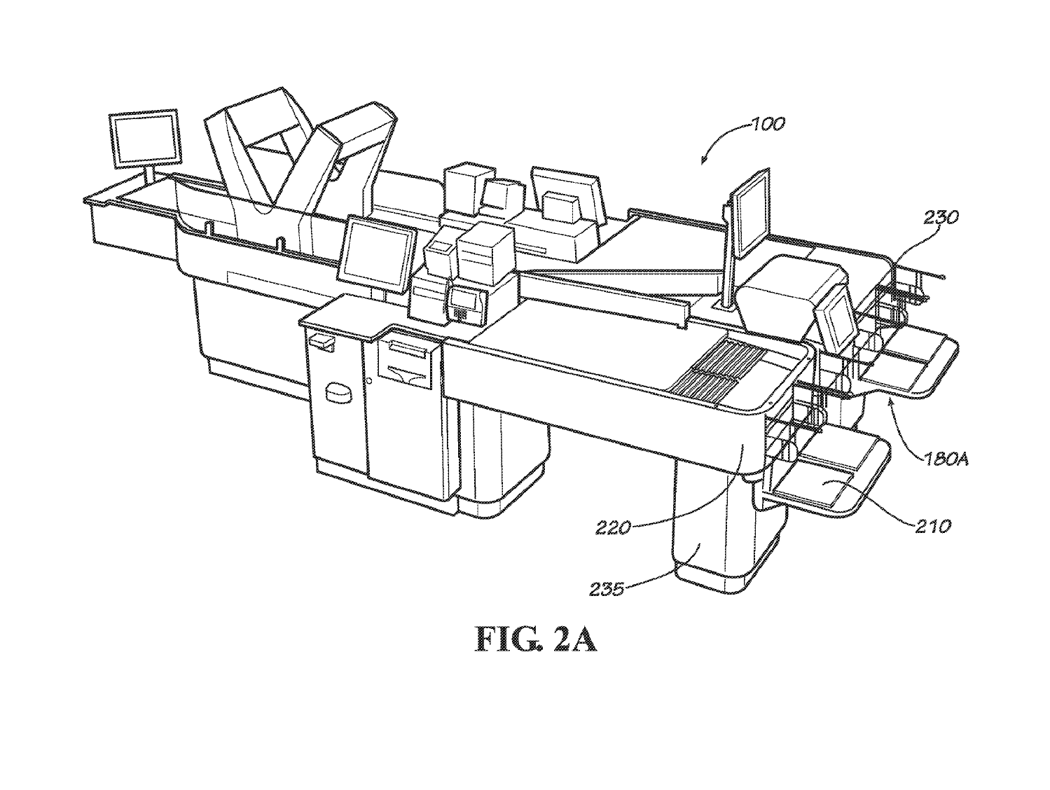

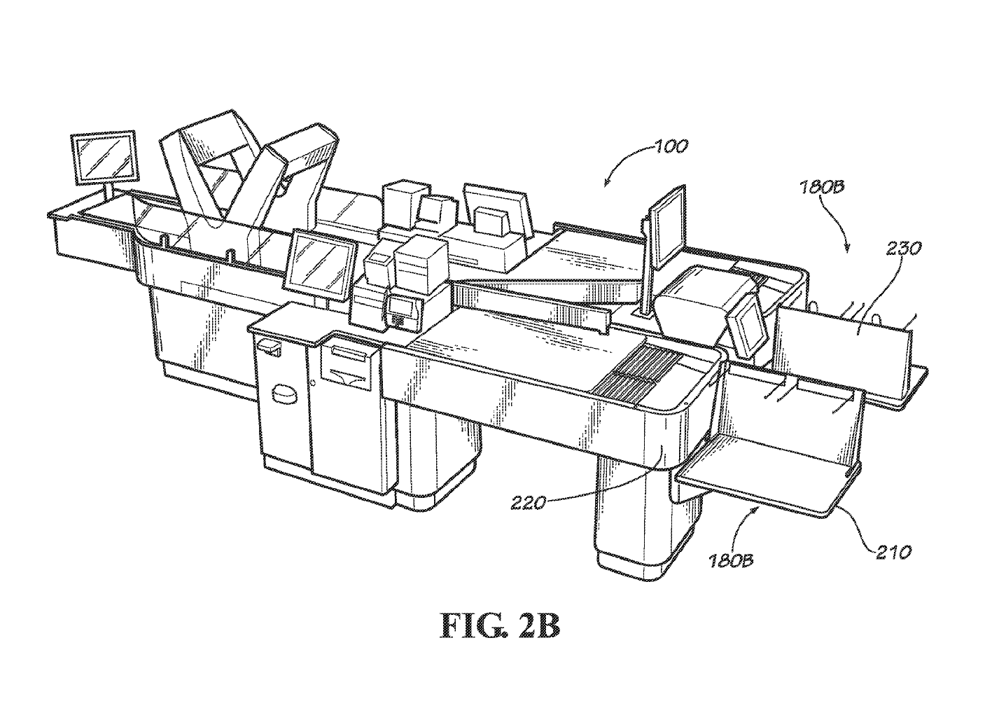

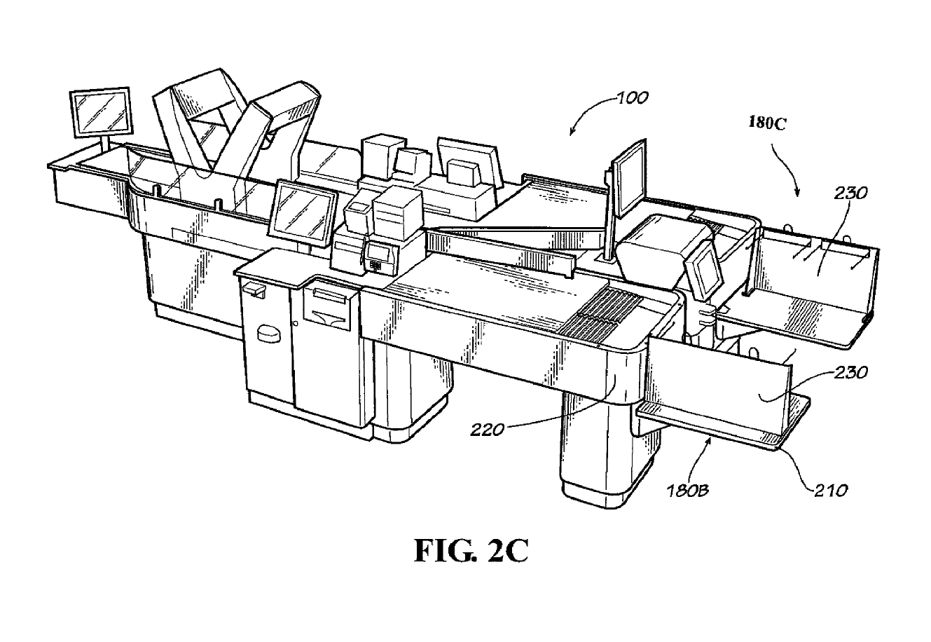

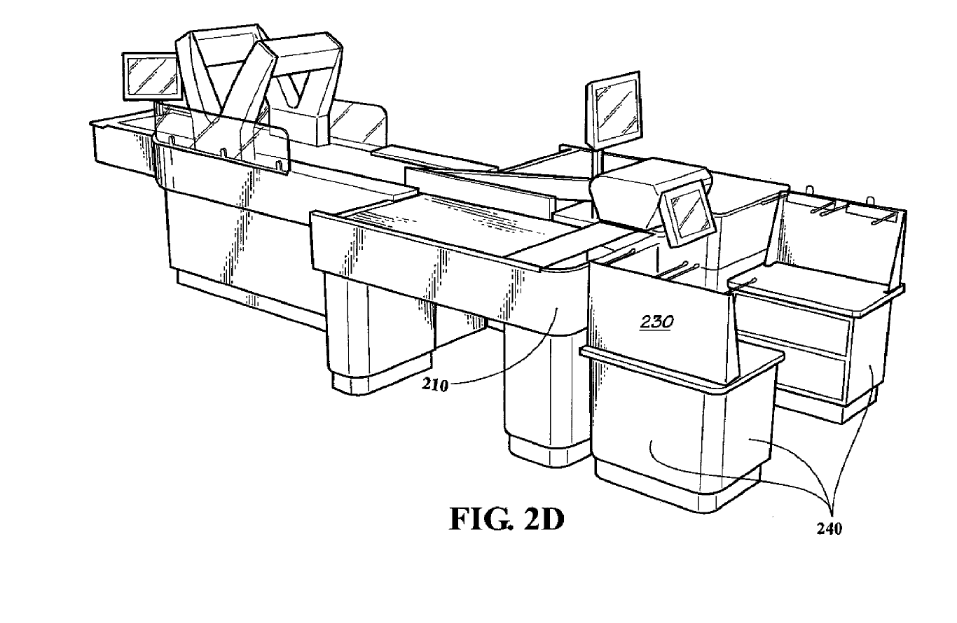

FIG. 2A illustrates an embodiment of the modular checkout stand system 100. This embodiment includes the same sections shown in FIG. 1, where the bagging platform assembly 180A has a first orientation, such that the longest side of the bag platform 210 is parallel to the end 220 of the outtake transport section 150. In this orientation, a vertical section 230 of the platform abuts the end 220 of the outtake transport section 150, and the bag platform 210 is horizontally oriented. In this embodiment, the bag platform 210 is supported only by the modular checkout stand system 100.

FIG. 2B illustrates an embodiment of the modular checkout stand system 100. This embodiment includes the same sections shown in FIG. 1, where the bagging platform assembly 180B has a second orientation, such that the longest side of the bag platform 210 extends outward from the end 220 of the outtake transport section 150 and the vertical section 230 is disposed in a central area. Bags placed on the bagging platform are thus easily accessible by customers standing at the edge of the outtake transport path 160. In this embodiment, the bag platform 210 is supported only by the modular checkout stand system 100.

FIG. 2C illustrates an embodiment of the modular checkout stand system 100. This embodiment includes the same sections shown in FIG. 1, where the bagging platform assembly 180C has a third orientation, such that the longest side of the bag platform 210 extends outward from the end 220 of the outtake transport section 150 and the vertical section 230 is disposed in an outer or lateral area. Bags (not shown) placed on the bagging platform are thus accessible by customers standing inward of the vertical section 230 along the outtake transport path 160. In this embodiment, the bag platform 210 is supported only by the modular checkout stand system 100. As can be seen, not every modular unit has or requires a frame 235.

FIG. 2D illustrates an embodiment of the modular checkout stand system 100. This embodiment includes the same sections shown in FIG. 1, and the bagging platform assembly 180D has the same third orientation as shown in FIG. 2C. However, instead of the bag platform 210 being supported by the modular checkout stand system 100, the bagging platform assembly 180D has a support section 240 (frame) underneath the bag platform 210.

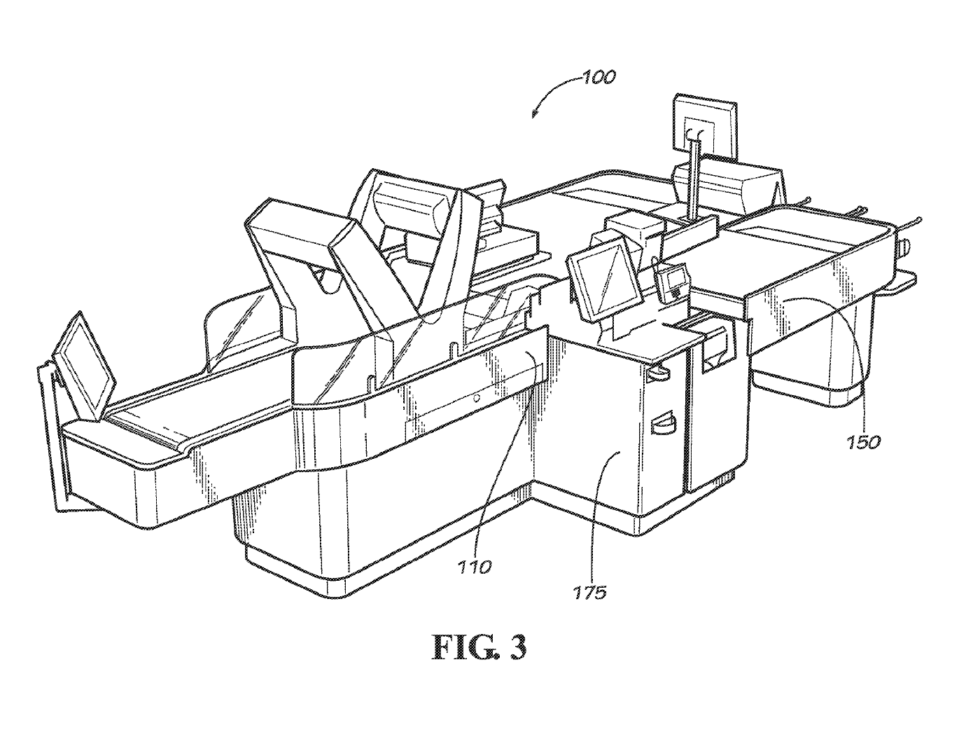

The modular checkout stand system 100 can be configured with a different location for the payment station 175. In the embodiment shown in FIG. 3, the payment station 175 is integrated into the main body of the modular checkout stand system 100, toward the end of the intake transport section 110 and the start of the outtake transport section 150. The payment station 175 is thus easily accessible to a customer during the scanning and bagging process, such that payment is facilitated as part of the scanning and bagging process.

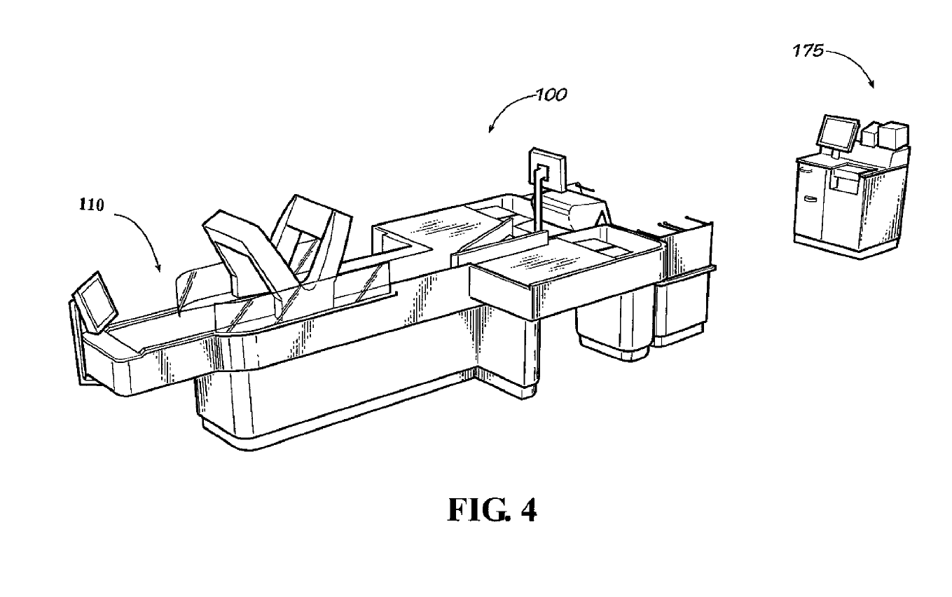

In the embodiment shown in FIG. 4, the payment station 175 is remote from the main body of the modular checkout stand system 100. This remote location allows another customer to begin scanning at the modular checkout stand system 100, while the exiting customer completes his/her transaction by paying at the remote payment station 175.

Specific components that can be used in embodiments of the modular checkout stand system 100 are shown in FIGS. 1 through 4. For example, the components illustrated in FIG. 1, include one or more of a touchscreen, a scanner, a printer, smart scale, a EFT device, a currency recycler, and a coin recycler. Various vendors, models, and makes can be utilized. However, the modules may require effort to operatively connect the components.

In another embodiment, the checkout stand can have an auxiliary set aside area that has a bag rack. A bagging station 170 can also be located at an end of the checkout stand housing where items are placed by an operator following reading of barcodes on the items. The bagging station may include a shelf and bag racks. The shelf and bag racks can be constructed to minimize the possibility of operator injury during scanning and bagging of items. For example, the shelf and bag racks may include rounded edges and/or padding. Further, one or more carousels can have bag racks and a hook for reusable or disposable bags mounted on a pocket for storing paper bags. The bagging stations can also be on the side of the checkout stand.

In another embodiment, the checkout stand can have an auxiliary set aside area on which fragile or small items can be placed to prevent these items from being damaged or lost on the checkout lane.

In one example, the time to scan, bag, and load a shopping cart using the checkout stand 100 was less than using a conventional checkout stand configuration. In many instances, the speed can be determined by the speed of the scanner.

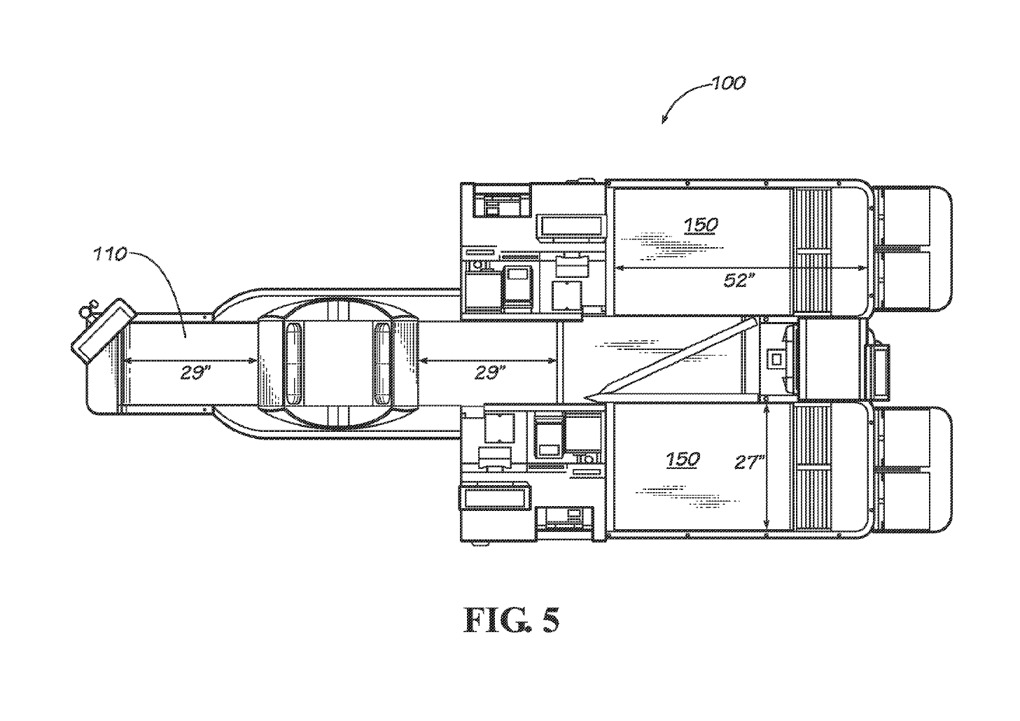

FIG. 5 shows dimension of certain aspects of a specific embodiment. The various sections of the modular checkout stand system 100 can be varied in size. For example, the length and width of the intake transport section 110 and of the outtake transport section 150 can be varied.

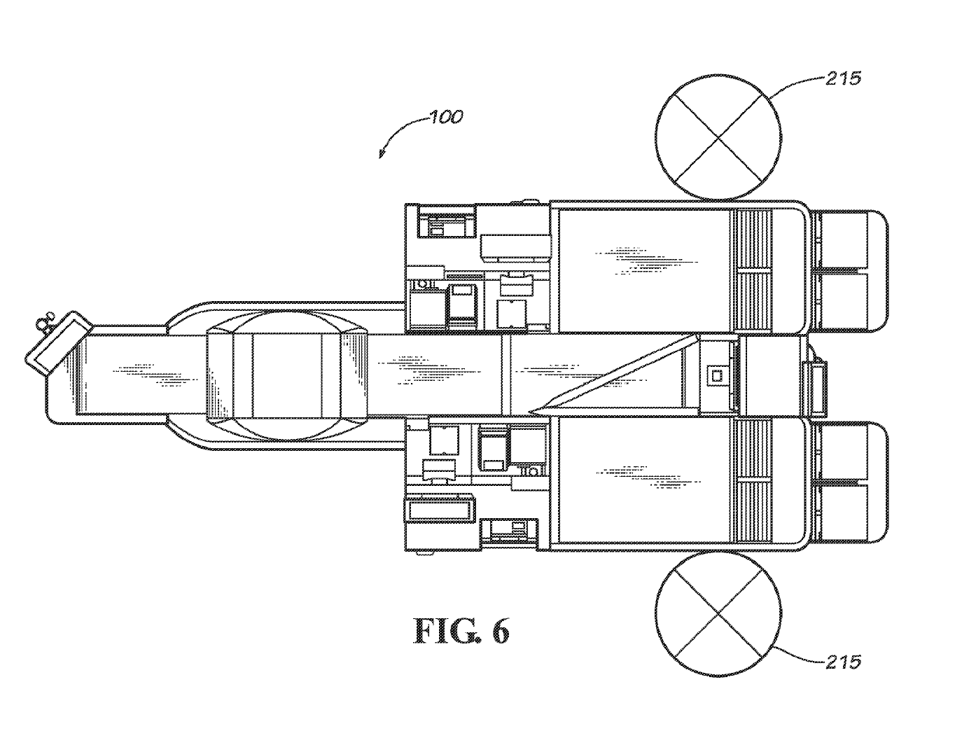

As illustrated in FIG. 6, the checkout stand 100 may include a carousel type bagging section 215.

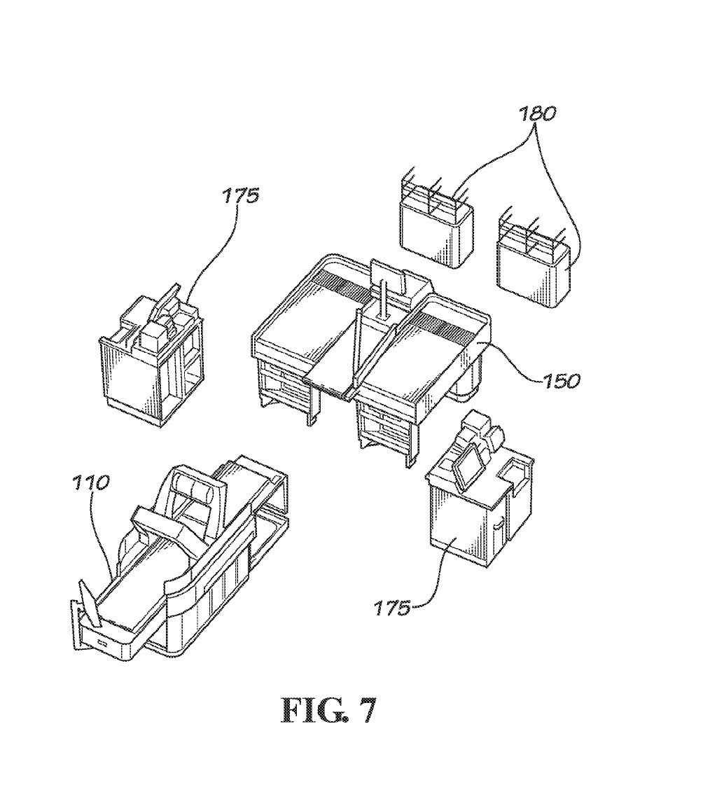

FIG. 7 illustrates the modular units of one specific embodiment. As may be seen from the figure, the intake section, the pay station or point of sale terminal (generally), the outtake transport section and the bagging units can be modular units. The modular units can be operatively connected to build the checkout stand system 100 at a specific site.

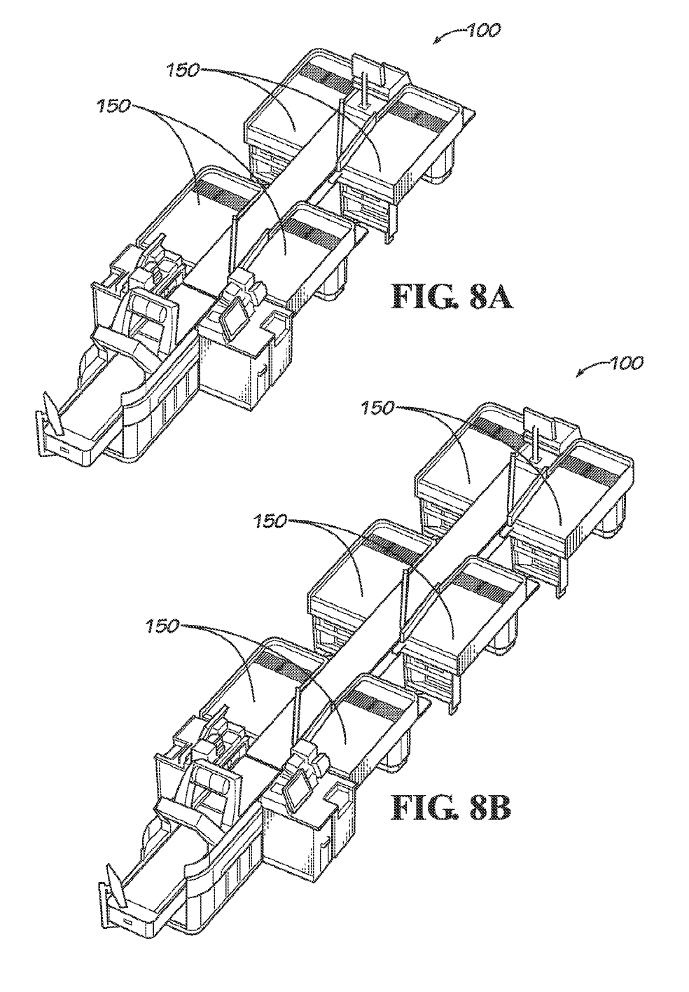

Specific embodiments can include a variation in the number of modular units, in including the number of outtake transport sections. As shown in FIG. 8A, the modular checkout stand 100 might be configured with two outtake transport sections 150. As shown in FIG. 8B, the modular checkout stand 100 may be configured with six outtake transport sections 150. Yet another is configured with more than six outtake transport sections (not shown). The limitation on the number of outtake transport sections or other units is space and checkout optimization.

The barcode reader 125 may be any barcode reader, including an optical barcode scanner. The barcode reader 125 may be located within a checkout counter, mounted on top of a checkout counter or incorporated within a hand-held device.

The checkout stand 100 can include the traditional features of a checkout stand. For example, one or more payment peripherals may alternatively, in combination, or in addition be separately mounted to the checkout stand housing adjacent the payment machine. In one example, a payment peripheral includes a card reader and a signature pad. Further, checkout stand 100 may include a light post for signaling customers that the checkout stand is available for assisted service operation and/or for signaling an attendant or store employee of different transaction conditions that require assistance. These items may be modular as well.

In certain specific embodiments, the checkout stand system can be constructed to include a frame which is free-standing, and a plurality of modules which mountable on the frame without requiring any manipulation of the modules. The checkout stand system can incorporate traditional components for attaching the modules or the frames, and may incorporates a quick disconnect mechanism that allows the retail establishments to install the checkout stand in an efficient, cost-effective manner.

Another specific embodiment includes a method for arranging a checkout stand by providing a series of modules that form the checkout stand; arranging the modules in a desired arrangement; and operatively coupling the modules together to form the checkout stand. The modules can include a scanner, a bagging station and a first conveyor. A further step can include coupling the scanner between the first conveyor and the bagging station. Another step can include coupling a plurality of outtake sections between the scanner and the bagging station. Yet another step can scanning a plurality of the items.

It should be understood by those skilled in the art that the exemplary embodiments of the present disclosure are not intended to limit the spirit and scope of the disclosure. Many variations and modifications will be evident to those skilled in the art and may be made without departing from the spirit and scope of the disclosure. Insofar as those variations and modifications are within the purview of the appended claims, they are to be considered as part of the present disclosure.

What is claimed is:

1. A checkout stand comprising:
(a) a scanner;
(b) an outtake section downstream of the scanner;
(c) a bagging sections downstream of the outtake section; and
(d) a point of sale terminal,
wherein the outtake section and the bagging station are modular units that are operatively linked at a site.

2. The checkout stand, further comprising:
(a) a conveyor coupled to the scanner for transporting items from an entry end of the conveyor to the scanner;

3. The checkout stand as claimed in claim 1, wherein the outtake section includes a plurality of outtake sections.

4. The checkout stand as claimed in claim 1, when the scanner is capable of reading barcodes.

5. The checkout stand as claimed in claim 3, wherein the scanner is a generally O-shaped barcode reader.

6. The checkout stand as claimed in claim 2, wherein the plurality of outtake stations form a gap that is wide enough for an operator to pass two of the items in parallel through the gap towards the bagging station.

7. The checkout stand as claimed in claim 1, further comprising a diverter section between the scanner and the outtake section, wherein the diverter section is divided into at least two pathways by a divider.

8. The checkout stand as claimed in claim 1, wherein the bagging station includes a carousel.

9. The checkout stand as claimed in claim 1, further comprising a plurality of bagging carousels.

10. The checkout stand as claimed in claim 1, wherein the checkout standing is a self-checkout stand.

11. The checkout stand as claimed in claim 1, further comprising a remote pay station.

12. A method for arranging a checkout stand:
(a) providing a series of modules that form the checkout stand;
(b) arranging the modules in a desired arrangement; and
(c) operatively coupling the modules together to form the checkout stand.

13. The method as claimed in claim 12, wherein the modules comprise: a scanner, a bagging station and a first conveyor.

14. The method as claimed in claim 12, further comprising the step of coupling the scanner between the first conveyor and the bagging station.

15. The method as claimed in claim 12, further comprising the step of coupling a plurality of outtake sections between the scanner and the bagging station.

16. The method as claimed in claim 14, further comprising the step of scanning a plurality of the items moving in parallel in a direction towards the bagging station by a barcode reader.

17. The method as claimed in claim 12, further comprising arranging a remote payment station.

18. A checkout stand comprising:
(a) a scanner;
(b) an outtake section downstream of the scanner having a frame capable of supporting the outtake section;
(c) a bagging section downstream of the outtake section having a frame capable of supporting the bagging section; and
(d) a point of sale terminal, wherein the outtake section and the bagging station are modular units that are operatively linked at a site; and the outtake section, the bagging section, and the point of sale terminal are each free-standing modules.
